(19) United States
(12) Patent Application Publication
(10) Pub. No.: US 2014/0211479 A1
(43) Pub. Date: Jul. 31, 2014

(54) LIGHT EMITTING DIODE ILLUMINATING DEVICE

(71) Applicant: HON HAI PRECISION INDUSTRY CO., LTD., New Taipei (TW)

(72) Inventors: CHUN-WEI LIANG, New Taipei (TW); KUANG-MING HSIAO, New Taipei (TW)

(73) Assignee: HON HAI PRECISION INDUSTRY CO., LTD., New Taipei (TW)

(21) Appl. No.: 14/149,826

(22) Filed: Jan. 8, 2014

(30) Foreign Application Priority Data
Jan. 31, 2013 (TW) 102103836

(51) Int. Cl. F21V 7/00

(52) U.S. Cl. CPC F21V 7/00
USPC 362/296.01

(57) ABSTRACT

A light emitting diode (LED) illuminating device includes a base, an LED substrate mounted on the base, at least one LED arranged on the LED substrate and an envelope. The envelope includes an open end fixed on the base, a top end opposite to the open end, and a reflection portion protruding from an inner surface of the top end and extending toward the LED substrate. A reflection layer is arranged on the reflection portion, light beams emitted by the at least one LED pass through the envelope to spread out.

### BACKGROUND

1. Technical Field

The present disclosure relates to light emitting diode (LED) illuminating devices, especially to an LED illuminating device with large light divergence angle.

2. Description of Related Art

Compared to many other kinds of illuminating devices, LEDs have many advantages, such as high luminous efficiency, low power consumption, and long service life. Yet, LEDs still have disadvantages. Because light emitted by LEDs is directional, the light divergence angle of an LED illuminating device is generally less than that of other kinds of illuminating devices, such as an electric incandescent lamp, a fluorescent lamp and a halogen lamp.

Therefore, what is needed is an LED illuminating device with large light divergence angle.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing an LED illuminating device in accordance with an exemplary embodiment.

FIG. 2 is a schematic, exploded view of the LED illuminating device of FIG. 1.

FIG. 3 is a schematic, cross-sectional view of the LED illuminating device taken along line III-III of FIG. 1.

FIG. 4 is a schematic view showing an envelope of the LED illuminating device of FIG. 1.

FIG. 5 is a schematic, cross-sectional view showing light paths of the LED illuminating device of FIG. 1.

FIG. 6 is a diagram showing a radiation pattern of the LED illuminating device of FIG. 1.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

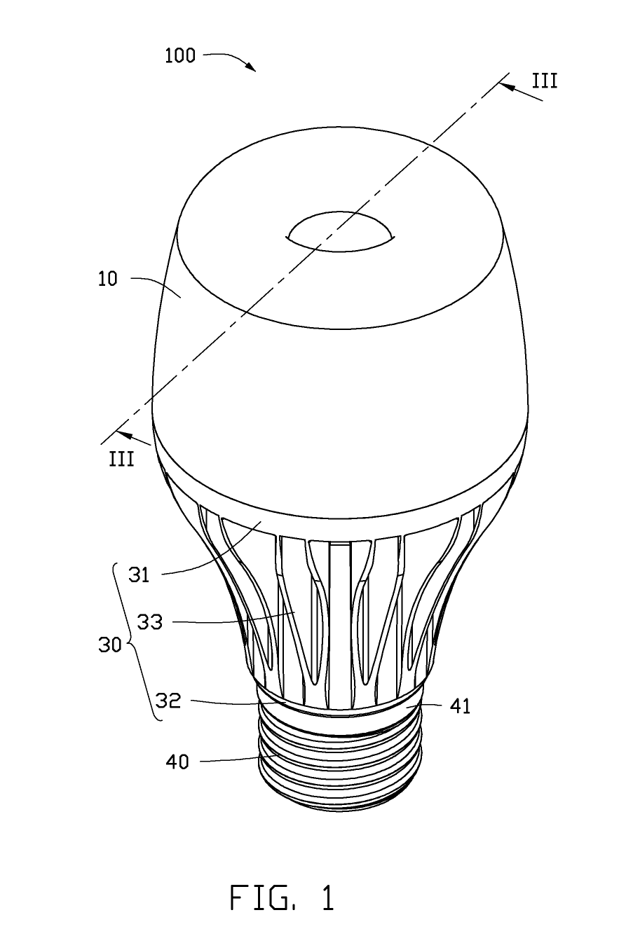

FIG. 1 shows a light emitting diode (LED) illuminating device 100, according to an embodiment. The LED illuminating device 100 includes an envelope 10, a base 30, and a connector 40. The base 30 includes a first end 31 and a second end 32, the envelope 10 is attached to the first end 31, the connector 30 is fixed on the second end 32. The base 30 further includes a number of cooling fins 33 arranged around its lateral surface to increase the heat dissipation area. The connector 40 is used to mate with a coupling connector to electrically connect the device 100 to a power source. An insulated ring 41 is arranged between the base 30 and the connector 40.

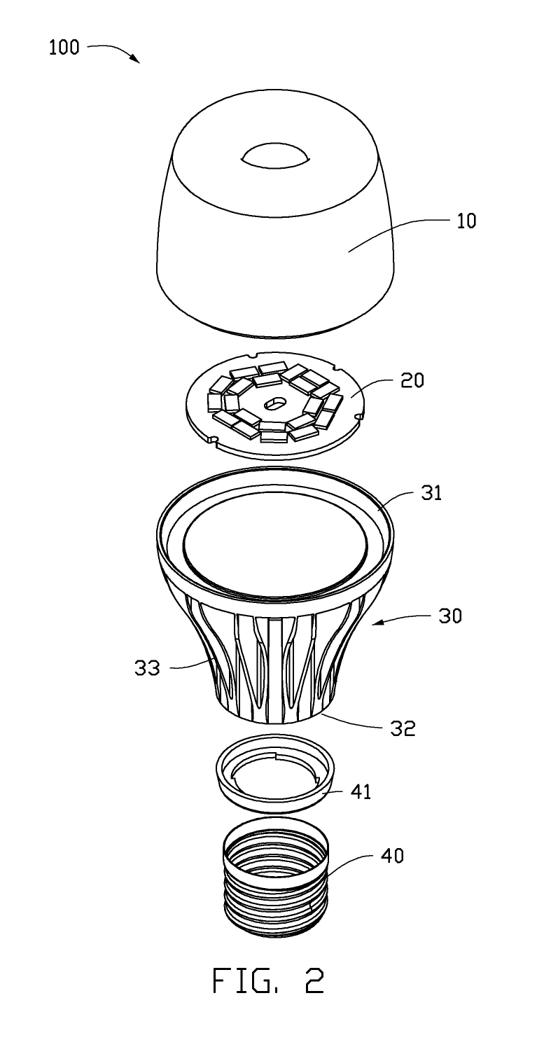

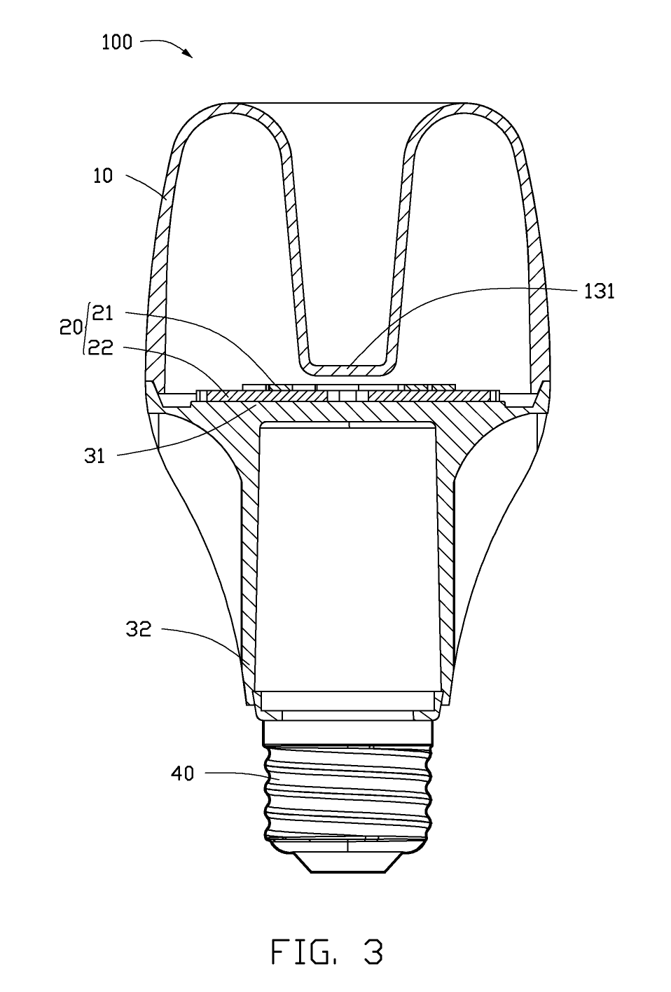

FIGS. 2 and 3 show that the device 100 further includes an LED substrate 20 fixed on the first end 31 of the base 30. At least one LED 21 is arranged on the LED substrate 20. The envelope 10 is fixed on the first end 31 of the base 30 by any suitable connection techniques, such as threaded connection, snap connection, or glue. The LED substrate 20 is located between the base 30 and the envelope 10, thus the light beams emitting from the LEDs 21 pass through the envelope 10 and spread out. The envelope 10 can be made of transparent or translucent material, such as transparent glass or plastic.

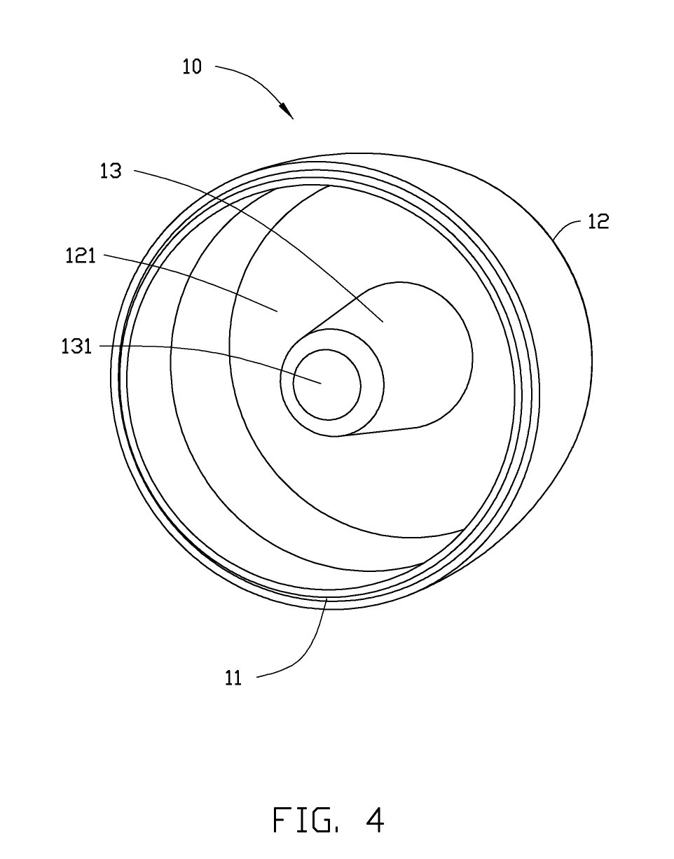

FIGS. 3 and 4 show that the envelope 10 is a hollow housing, and includes a top end 12 and an open end 11 opposite to the top end 12. The open end 11 of the envelope 10 is fixed on the first end 31 of the base 30, thus connecting the base 30 and the envelope 10 together. The LED substrate 20 is located between the base 30 and the envelope 10, and faces the top end 12 of the envelope 10. A reflection portion 13 protrudes from a center portion of the top end 12 of the envelope 10, and extends toward the LED substrate 20. A concave is surrounded by the reflection portion 13 and exposed outwards at the top end 12. A height of the reflection portion 13 is less than a height of the envelope 10. The reflection portion 13 includes a free end 131, which is away from the top end 12 of the envelope 10. The reflection portion 13 is tapered from the top end 12 to the free end 131.

In an embodiment, the reflection portion 13 is a hollow or solid post protruding from the inner surface 121 of the top end 12 of the envelope 10, and extending toward the LED substrate 20. In other embodiments, the reflection portion 13 is a separate post attached to the inner surface of the top end 12 by any suitable connection techniques, such as threaded connection, snap connection or glue.

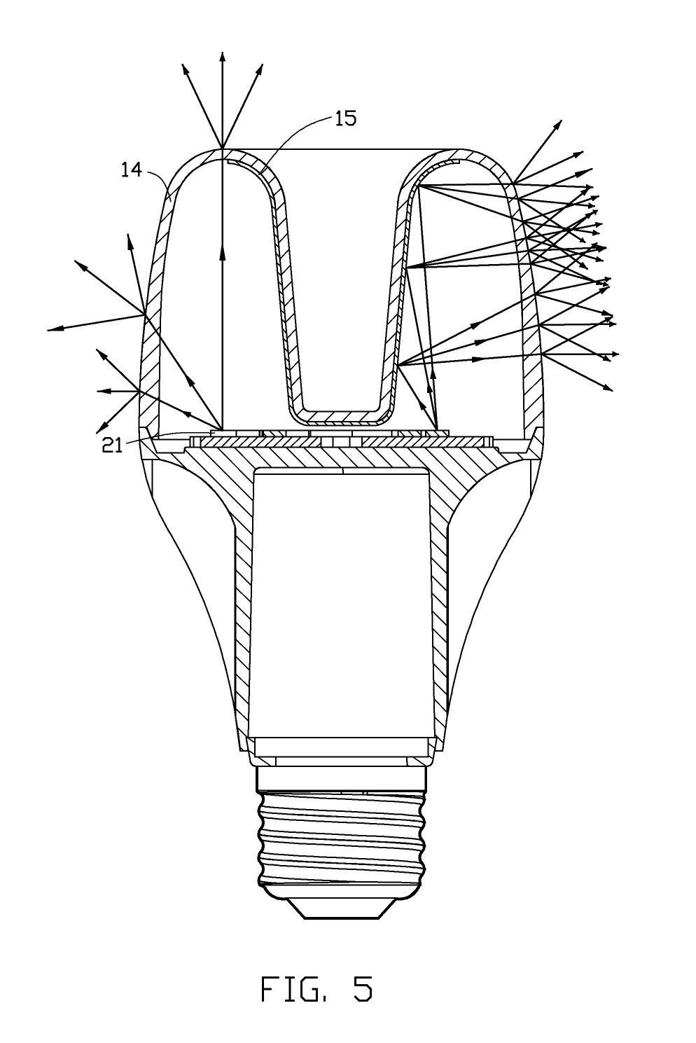

FIG. 5 shows that a reflection layer 15 is arranged on part or all of surface of the reflection portion 13, the reflection layer 15 is a coating of white scattering paint material or other diffuse materials, thus forming a Lambert reflector surface diffusing the light beams. In an embodiment, part or all of the inner surface 121 of the top end 12 is also covered by the reflection layer 15. In other embodiments, the reflection layer 15 covers the inner surface 121 of the top end 12 and part of lateral surface of the envelope 10. Because the envelope 10 is transparent or translucent, the remaining portion of the envelope 10, which is not covered by the reflection layer 15 forms a transmission region 14.

In this embodiment, the LED substrate 20 includes a printed circuit board 22, the number of the LEDs 21 are arranged in a circle on the print circuit board 22, the free end 131 of the reflection portion 13 faces the center of the circle.

Some of the light beams emitted by the LED 21 reach the transmission region 14 directly, and pass though the transmission region 14 and spread out. The remaining light beams emitted by the LED 21 reach the reflection layer 15, and are reflected back. Part of the reflected light travels to the transmission region 14 and can spread out via passing though the transmission region 14. The remaining reflected light travels to the reflection layer 15 and will be reflected again and repeat the above process until finally they spread outside through the transmission region 14.

Because some of the light beams emitted by the LED 21 are reflected by the reflection layer 15, the directions of the light beams are changed. The light beams emitted by the LED 21 can reach various locations of each of the transmission region 14 at various angles. The light divergence angle of the LED illuminating device 100 increases correspondingly.

In one embodiment, a coating of scatter material or a film of scatter material can be arranged on the inner/outer surface of the transmission region 14 of the envelope 10. In another embodiment, a number of accentuated portions such as protuberances and/or recesses can be defined on the inner/outer surface of the transmission region 14 of the envelope 10 scattering the light beams.

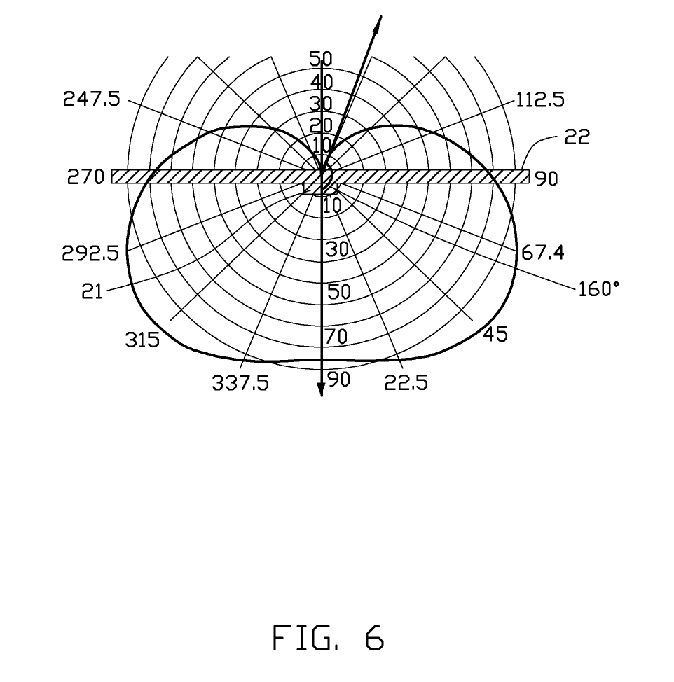

The light divergence angle of a common LED is 180 degrees. FIG. 6 shows the light divergence angle of the LED illuminating device 100 is greater than 320 degrees.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A light emitting diode (LED) illuminating device comprising:
a base;
an LED substrate mounted on the base;
at least one LED arranged on the LED substrate; and
an envelope comprising an open end fixed on the base, a top end opposite to the open end, and a reflection portion protruding from the top end and extending toward the LED substrate;
wherein a reflection layer is arranged on the reflection portion; a height of the reflection portion is less than a height of the envelope, and light beams emitted by the at least one LED pass through the envelope to spread out.

2. The LED illuminating device of claim 1, wherein the reflection portion is a hollow post protruding from the top end of the envelope, and extending toward the at least one LED on the LED substrate.

3. The LED illuminating device of claim 1, wherein the envelope defines a concave surrounded by the reflection portion, the concave being exposed outwards at the top end.

4. The LED illuminating device of claim 1, wherein the reflection layer covers part of the inner surface of the top end.

5. The LED illuminating device of claim 1, wherein the reflection portion is tapered from the top end to the free end.

6. The LED illuminating device of claim 1, wherein the reflection layer is a coating of white scattering paint material.

7. The LED illuminating device of claim 1, wherein the envelope is made of transparent or translucent plastic or glass.

8. The LED illuminating device of claim 1, wherein a number of protuberances and/or recesses are defined on the surface of the envelope to scatter the light beams.

9. The LED illuminating device of claim 1, wherein the at least one LED comprises a plurality of LEDs arranged in a circle on the LED substrate, and a free end of the reflection portion faces a center of the circle.
